(19) United States
(12) Patent Application Publication
(10) Pub. No.: US 2006/0143207 A1
(43) Pub. Date: Jun. 29, 2006

(54) Cyrillic to Latin script transliteration system and method

(75) Inventors: Andre McQuaid, South County Business Park (IE); Andrej Koklic, Celje (SI); Colin Fitzpatrick, South County Business Park (IE); Simon J. Minnis, Uopaedstown (IE); Silvana Hadzic, Novi Sad (YU)

Correspondence Address: MERCHANT & GOULD PC, P.O. BOX 2903, MINNEAPOLIS, MN, 55402-0903, US

(73) Assignee: Microsoft Corporation, Redmond, WA (US)

(21) Appl. No.: 11/026,969

(22) Filed: Dec. 29, 2004

(51) Int. Cl. G06F 17/00; G06F 7/00

(52) U.S. Cl. 707/101

(57) ABSTRACT

Embodiments of the present invention relate to methods, systems and computer-readable media for transliteration between Cyrillic and Latin script in a software product. An embodiment of this transliteration system and method comprises loading a text of characters and words in one of a Cyrillic or Latin script into a character transliteration module. This module converts each character in the one of a Cyrillic or Latin script into a corresponding opposite transliterated Cyrillic or Latin character. Then each word is examined in a word capitalization and exception module that compares each transliterated word against a set of predetermined grammatical rules to determine whether there are exceptions in capitalization. If there are, then appropriate internal capitalization of characters is added. Each word of the text to be transliterated is sequentially examined and converted until all words have been examined.

### TECHNICAL FIELD

The invention relates generally to the field of computer software products. More particularly, the invention relates to methods and systems for producing language specific versions of text in a software product.

### BACKGROUND OF THE INVENTION

Users of word processing and text intensive visual aid presentation software such as Microsoft® Word and Microsoft® PowerPoint programs, in Bosnian and Serbian languages, for example, are required to provide copies of documents in both Cyrillic and Latin script. As a result, typically the user must retype an entire document twice, once in Cyrillic script and once in Latin script. This is extremely time intensive and redundant.

There is thus a need for a method and system for transliteration capability back and forth between these two language scripts that is convenient for the user and robust enough to handle the semantic differences between the language scripts. It is with respect to these needs that the present invention has been developed.

### SUMMARY OF THE INVENTION

Embodiments of the present invention are a system and a method for transliterating either language script easily and at the user's command. The method involves loading a text of characters and words in one of a Cyrillic or Latin script into a character transliteration module and converting each character in the one of a Cyrillic or Latin script into a corresponding opposite Cyrillic or Latin character. Each word is then sequentially also loaded into a word capitalization exception module where the word is examined for occurrences of any capitalization exceptions. If there are exceptions, one or more predetermined rules may be applied, and if the word matches an applicable predetermined rule, the character capitalization in the word is modified in accordance with the applicable predetermined resource rule.

In accordance with other aspects, the present invention relates to a system for transliterating Cyrillic to Latin script and vice versa that involves loading a text of characters and words in one of a Cyrillic or Latin script into a character transliteration module and converting each character in the one of a Cyrillic or Latin script into a corresponding opposite Cyrillic or Latin character. Each word is also sequentially loaded into a word capitalization exception module where the word is examined for occurrences of any capitalization exceptions. If there are exceptions, one or more predetermined rules may be applied, and if the word matches an applicable predetermined rule, the character capitalization in the word is modified in accordance with the applicable predetermined resource rule. This results in a system for script transliteration between Cyrillic and Latin scripts, and vice versa, that is fast, simple to use, and permits substantial productivity gains to the user.

The invention may be implemented as a computer process, a computing system or as an article of manufacture such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

These and various other features as well as advantages, which characterize the present invention, will be apparent from a reading of the following detailed description and a review of the associated drawings.

### BRIEF DESCRIPTION OF THE DRAWINGS

FIG. 1 illustrates, conceptually, a transliteration system between Cyrillic and Latin scripts according to one embodiment of the present invention.

FIG. 2 illustrates an example of a suitable computing system environment on which 25 embodiments of the invention may be implemented.

FIG. 3 is a flowchart illustrating operations in a software product utilizing a transliteration method according to one embodiment of the present invention.

FIG. 4 is a tabular illustration of the one to one correspondence of Cyrillic characters to Latin characters for both capitalized characters and lower case characters.

FIG. 5 is a listing of an exemplary style sheet for Cyrillic characters in accordance with the present invention.

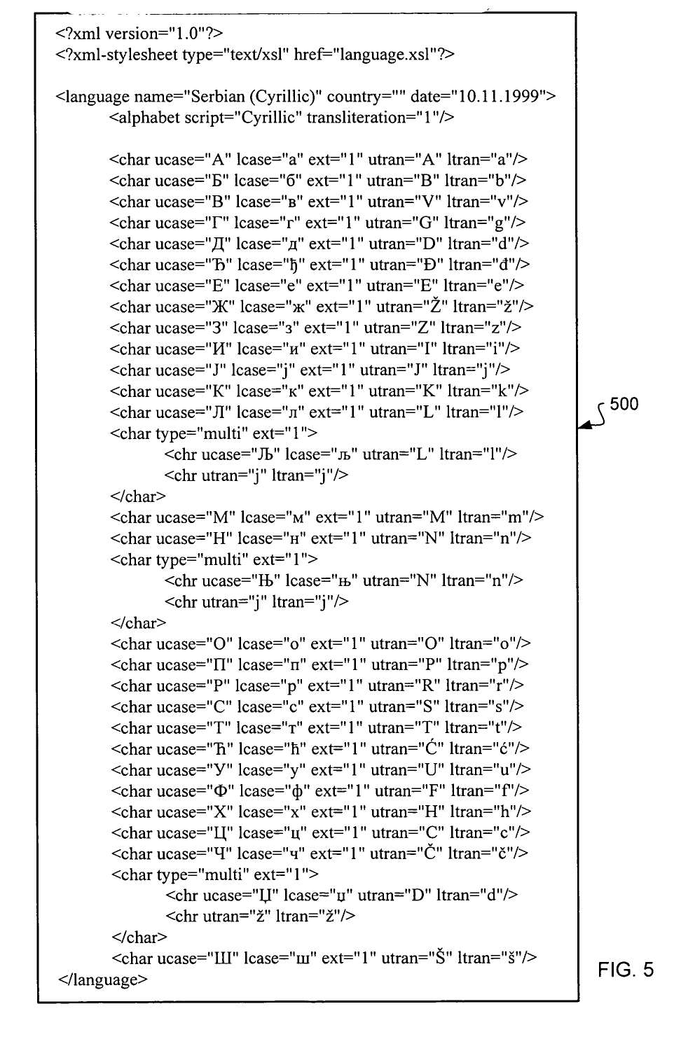

### DETAILED DESCRIPTION OF THE INVENTION

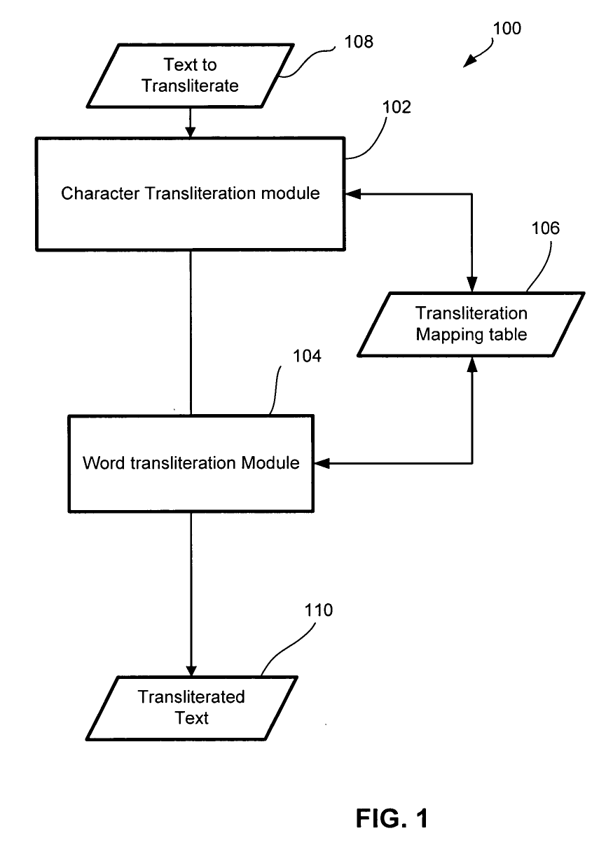

FIG. 1 illustrates, conceptually, a transliteration system 100 according to one embodiment of the present invention. In an application such as Microsoft® Word or an Officeg application such as PowerPoint, a text document or text string can be converted between Cyrillic and Latin script languages by highlighting the document or text and calling the transliteration system 100. The transliteration system then automatically converts the highlighted text script to the desired one of the Cyrillic or Latin script.

The system 100 includes a character transliteration module 102 and a word capitalization module 104 that both draw character data from a transliteration character database 106. Text that is to be transliterated 108 is highlighted or otherwise identified by a user as needing transliteration. This text or script 108 is then fed first to the character transliteration module where all the script 108 is transliterated, and then to a word transliteration module 104. Both modules draw from the transliteration-mapping table 106 in order to generate transliterated text data 110.

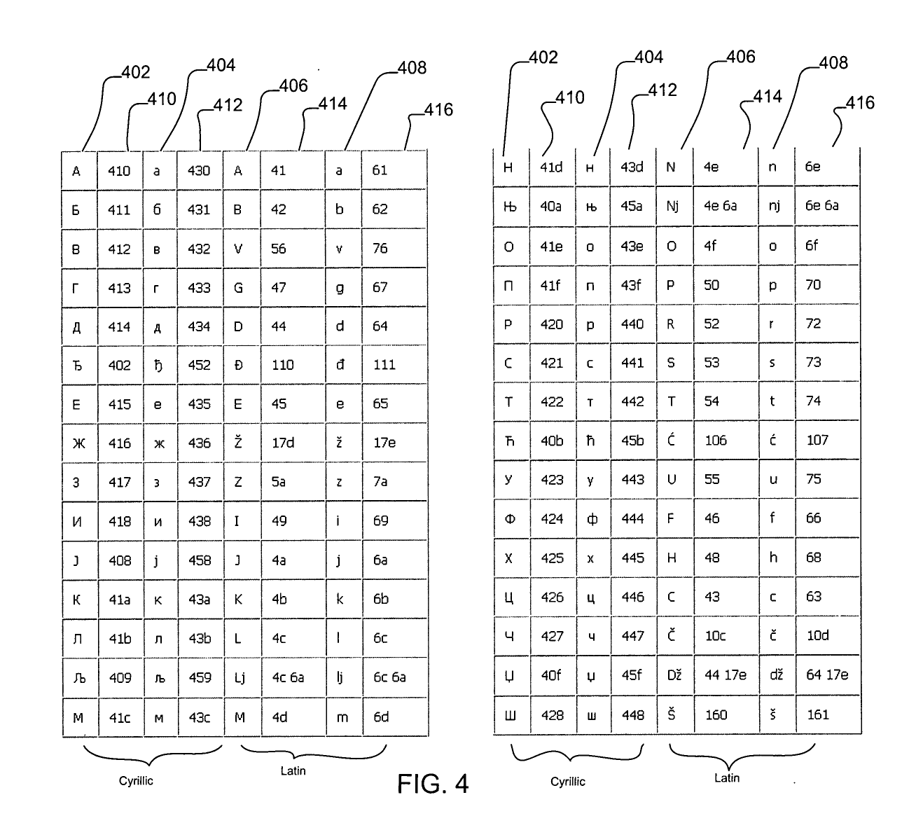

The Cyrillic characters with their corresponding Latin characters are shown in the table 400 of FIG. 4. Here the capital Cyrillic characters 402 and lower case Cyrillic characters are listed with their corresponding Unicode 410 and 412 respectively. Adjacent each set of Cyrillic characters are the corresponding Latin capital characters 406 and lower case characters 408 along with their corresponding Unicode numbers 414 and 416 respectively. There is a one-to-one correspondence between the characters in these two languages. However, capitalizations are somewhat different in each language depending on the syntax in which they are used. Sometimes characters are internally capitalized within a word. This is the reason for requiring a word transliteration module 104 in the system in accordance with the present invention. The transliteration module 104 contains the rules that apply to these special case capitalizations.

In three cases a single Cyrillic character maps to two Latin characters. These are: Jb into Lj, Hb into Nj, and LI into D\check{z}. This is fine if they are lowercase characters as the lowercase Cyrillic character simple maps to two lowercase Latin characters, and vice versa. However, when the Cyrillic character is capitalized, a question arises: Should the second Latin character in the mapping be lowercase or uppercase (the first Latin character will definitely be uppercase)? This can only be answered by considering the word in which the characters reside. There are a number of rules that govern this. These rules basically look at the next character's case to determine the case of the second Latin character. The following rules are exemplary and regard usage of capital and small letters involving combination characters in Cyrillic script with 2 characters in Serbian (Latin).

1. At the beginning of any sentence, Latin double character letters should be written with the first letter always a capital letter and second letter a small letter. Thus for Latin to Cyrillic script:
Lj into Jb,
Nj into [symbol]
D\check{z} into

[symbol]

2. In titles, letters LJ, NJ and D\check{Z} should be always written with capital letters. Thus:
LJ into Jb
NJ into [symbol]
D\check{z} into

[symbol]

3. When using these three combinations of letters in the middle of sentences, the letters are always small. Thus:
Lj into [symbol]
nj into [symbol]
d\check{z} into

[symbol]

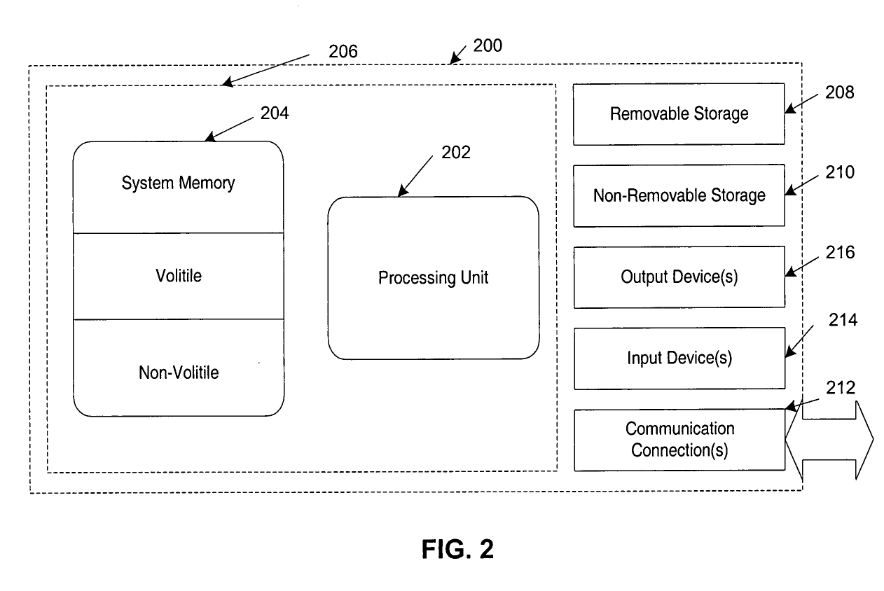

FIG. 2 illustrates an example of a suitable computing system environment on which embodiments of the invention may be implemented. This system 200 is representative of one that may be used as a stand-alone computer or to serve as a redirector and/or servers in a website service. In its most basic configuration, system 200 typically includes at least one processing unit 202 and memory 204. Depending on the exact configuration and type of computing device, memory 204 may be volatile (such as RAM), non-volatile (such as ROM, flash memory, etc.) or some combination of the two. This most basic configuration is illustrated in FIG. 2 by dashed line 206. Additionally, system 200 may also have additional features/functionality. For example, device 200 may also include additional storage (removable and/or non-removable) including, but not limited to, magnetic or optical disks or tape. Such additional storage is illustrated in FIG. 2 by removable storage 208 and non-removable storage 210. Computer storage media includes volatile and nonvolatile, removable and non-removable media implemented in any method or technology for storage of information such as computer readable instructions, data structures, program modules or other data. Memory 204, removable storage 208 and non-removable storage 210 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by system 200. Any such computer storage media may be part of system 200.

System 200 may also contain communications connection(s) 212 that allow the system to communicate with other devices. Communications connection(s) 212 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

System 200 may also have input device(s) 214 such as keyboard, mouse, pen, voice input device, touch input device, etc. Output device(s) 216 such as a display, speakers, printer, etc. may also be included. All these devices are well know in the art and need not be discussed at length here.

A computing device, such as system 200, typically includes at least some form of computer-readable media. Computer readable media can be any available media that can be accessed by the system 200. By way of example, and not limitation, computer-readable media might comprise computer storage media and communication media.

The logical operations of the various embodiments of the present invention are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations making up the embodiments of the present invention described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims attached hereto.

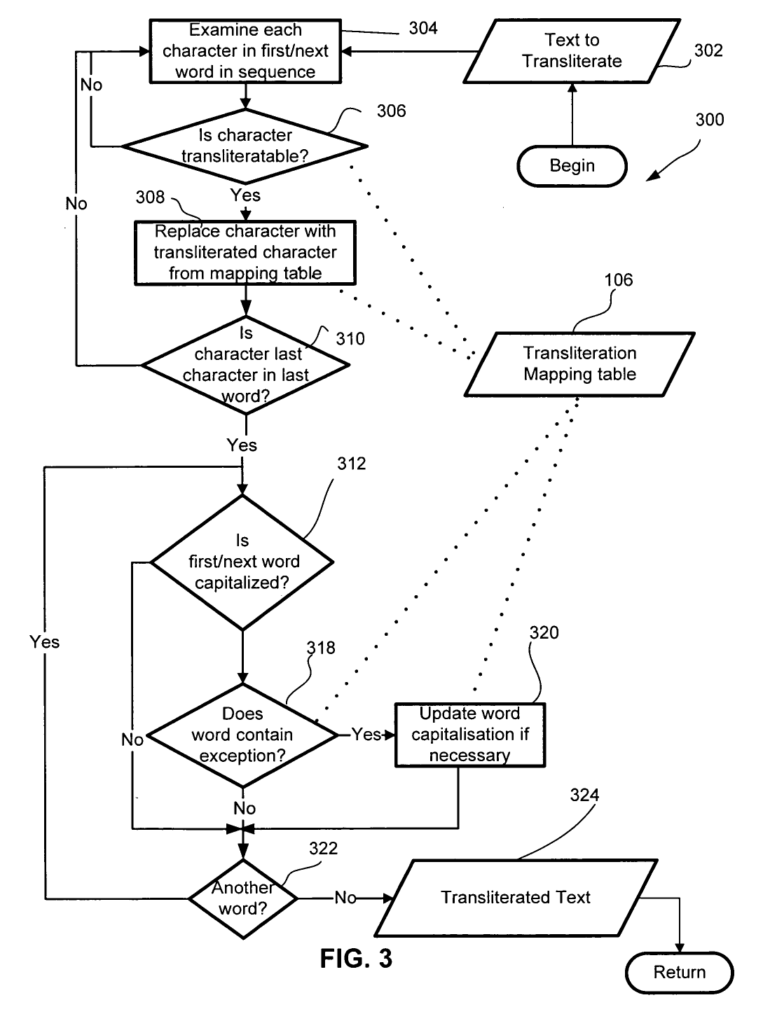

FIG. 3 is a flowchart illustrating operational flow 300 of the transliteration system and method according to one embodiment of the present invention. In this example, operation begins with text loading operation 302. In operation 302 the user highlights the text to be transliterated. Alternatively, the user may call a dialog that provides a predetermined set of choices for transliteration, e.g., all document text, a subset of the document, etc. Once the text or script to be transliterated is identified, control transfers to operation 304. In operation 304 the first/next character in the first/next word in sequence is examined. Control then transfers to query operation 306.

In query operation 306, the question is asked whether the first/next character in the word being examined is transliteratable. If there is a corresponding character in the opposite language, then control transfers to operation 308. However, if the character is not transliteratable, the character remains unchanged and control returns to operation 304 for examination of the next character in sequence.

In operation 308, the transliteration mapping table 106 is accessed to provide the appropriate replacement character, an example of which is found in FIG. 4. This transliterated character replaces the character being examined. Control then transfers to query operation 310.

Query operation 310 asks whether the character under examination is the last character in the last word in the script to be transliterated. If the character being examined is the last character in the last word in the script sequence, control transfers to query operation 312. If it is not the last character, control transfers back to operation 304 and the next character is examined as described above.

In query operation 312, the question is asked whether the first/next word in the script that was transliterated is capitalized. If the answer is yes, control transfers to operation 318. If the first/next word is not capitalized, transliteration of the current word is complete, and control transfers to query operation 322. If the first/next word is capitalized control then transfers to query operation 318.

Query operation 318 examines the word to determine whether the word contains a capitalization exception. This occurs in certain situations in which a letter within the mid portion of the current word is capitalized. However, this only occurs in certain situations that can be characterized by a set of grammar rules also contained in the transliteration mapping table 106. If the word contains an exception, control transfers to operation 320. If not, control transfers to query operation 322.

In operation 320 the word is checked against rules from the mapping table 106 in order to determine whether a character within the transliterated current word should be capitalized. If the check finds that a rule is matched, the requisite character in the word is capitalized, and control transfers to operation 322. The following rules are exemplary and regard usage of capital and small letters involving combination characters in Cyrillic script with 2 characters in Serbian (Latin).

1. At the beginning of any sentence, Latin double character letters should be written with the first letter always a capital letter and second letter a small letter. Thus for Latin to Cyrillic script:
Lj into Jb
Nj into [symbol]
D\check{z} into

[symbol]

2. In titles, letters LJ, NJ and D\check{Z} should be always written with capital letters. Thus:
LJ into Jb
NJ into [symbol]
D\check{z} into

[symbol]

3. When using these three combinations of letters in the middle of sentences, the letters are always small. Thus:
Lj into [symbol]
nj into [symbol]
d\check{z} into

[symbol]

In query operation 322, the current transliterated word is complete, and thus transferred to the transliterated text data store 324, and the query is made whether there is another word in the transliterated script sequence. If the answer is no, control transfers to operation 324, which returns control to the calling program, or to the user. If the answer is yes, there is another transliterated word, control transfers back to operation 312 where the next word is examined for capitalization. The process from 312 through 322 is repeated as many times as necessary until all the words in the transliterated script are examined for capitalization exceptions, thus completing transliteration of the desired text contained in operation 324.

Although the invention has been described in language specific to computer structural features, methodological acts and by computer readable media, it is to be understood that the invention defined in the appended claims is not necessarily limited to the specific structures, acts or media described. As an example, other types of data may be included in the language map in place of the string data discussed herein. Additionally, different manners of referencing the language specific data of the language map from the system calls in base product may be used. Therefore, the specific structural features, acts and mediums are disclosed as exemplary embodiments implementing the claimed invention.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

What is claimed is:

1. A method of transliterating a text between Cyrillic and Latin script in a software program, the method comprising:
loading a text of characters and words in one of a Cyrillic or Latin script into a character transliteration module;
converting each character in the one of a Cyrillic or Latin script into a corresponding opposite transliterated Cyrillic or Latin character;
loading each transliterated word into a word capitalization exception module;
examining each word in the script for occurrences of any capitalization exceptions;
applying one or more predetermined rules to each word having a capitalization exception; and
if the word matches an applicable predetermined rule, modifying character capitalization in the word in accordance with the applicable predetermined resource rule.

2. A system comprising:
a processor; and
a memory coupled with an readable by the processor and containing a series of instructions that, when executed by the processor, cause the processor to
load a text of characters and words in one of a Cyrillic or Latin script into a character transliteration module;
convert each character in the one of a Cyrillic or Latin script into a corresponding opposite Cyrillic or Latin character;
load each transliterated word into a word capitalization exception module;
examine each transliterated word in the script for occurrences of any capitalization exceptions;
apply one or more predetermined rules to each transliterated word having a capitalization exception; and
if the word matches an applicable predetermined rule, modifying character capitalization in the transliterated word in accordance with the applicable predetermined resource rule.

3. A computer readable medium encoding a computer program of instructions for executing a computer process for transliteration of script between Cyrillian and Latin scripts for use in Serbian and Bosnian languages, said computer process comprising:
loading a text of characters and words in one of a Cyrillic or Latin script into a character transliteration module;
converting each character in the one of a Cyrillic or Latin script into a corresponding opposite transliterated Cyrillic or Latin character;
loading each transliterated word into a word capitalization exception module;
examining each word in the script for occurrences of any capitalization exceptions;
applying one or more predetermined rules to each transliterated word having a capitalization exception; and
if the transliterated word matches an applicable predetermined rule, modifying character capitalization in the transliterated word in accordance with the applicable predetermined resource rule.
